(19) United States
(12) Patent Application Publication
(10) Pub. No.: US 2004/0028381 A1
(43) Pub. Date: Feb. 12, 2004

(54) Video recording/reproducing apparatus and a storage device control method thereof

(76) Inventor: Eung-Sun Kim, Suwon-city (KR)

Correspondence Address: Joseph J. Buczynski, Roylance, Abrams, Berdo & Goodman, L.L.P., Suite 600, 1300 19th Street, Washington, DC, 20036, US

(21) Appl. No.: 10/632,865

(22) Filed: Aug. 4, 2003

(30) Foreign Application Priority Data
Aug. 8, 2002 (KR) 2002-46941

(51) Int. Cl. H04N 5/783

(52) U.S. Cl. 386/68; 386/81; 386/82

(57) ABSTRACT

A video recording/reproducing apparatus and a storage device control method. The video recording/reproducing apparatus temporarily stores a received video signal in a buffer area allocated in a storage device if a command for temporary storage is received from an external input unit to temporarily store in the temporarily allocated buffer area of the storage device built in the video recording/reproducing apparatus a certain amount of the video signal received from a video signal source. Further, the video recording/reproducing apparatus records in the storage device in a long-term basis the video signal temporarily stored in the buffer area according to a set recording format if a recording command instructing a long-term recording process for the temporarily stored video signal of the buffer area is received from the external input unit. The apparatus enables a user to selectively allocate a buffer area and to produce and keep an A/V data file for the temporarily stored video signal for a long time.

This application claims benefit under 35 U.S.C. § 119 from Korean Patent Application No.2002-46941, filed on Aug. 8, 2002, the entire content of which is incorporated herein by reference.

### BACKGROUND OF THE INVENTION

1. Field of the Invention

The present invention relates to a video recording/reproducing apparatus and a storage device control method thereof, and more particularly to a video recording/reproducing apparatus and a storage device control method thereof enabling a user to easily use a time-delayed viewing function supported in the video recording/reproducing apparatus.

2. Description of the Related Art

A video recording/reproducing apparatus capable of recording and reproducing broadcast signals to and from a recording medium has extended its functions with the development of digitization and compression technologies on the broadcast signals.

It is a trend that video recording/reproducing apparatus recently appearing in the market adopt a hard disc drive (HDD) which is a mass storage device. The HDD uses addresses to enable random access which is a method directly accessing desired data. The HDD also transmits data at a high speed, and can be scaled up to a mass volume for storage, so that it is used as an audio and video data recording device.

It is also a trend that such a video recording/reproducing apparatus has been developed to support the uses of diverse video sources such as satellite broadcasts, cable broadcasts, network broadcasts through the internet, and so on.

However, the conventional video recording/reproducing apparatus has a problem that received video signals can be stored only in a buffer area allocated in a manufacturing process as the video signals are temporarily stored for reserved recordings and time-delayed viewings.

### SUMMARY OF THE INVENTION

Accordingly, it is an object of the present invention to provide a video recording/reproducing apparatus and a storage device control method thereof capable of temporarily storing video signals receivable in the apparatus in a storage device by an amount selectively allocated by a user, and recording necessary video signals in audio/video (A/V) data files.

In order to achieve the above and other objects, a video recording/reproducing apparatus according to an embodiment of the present invention comprises an input unit, such as a remote control external of the video recording/reproducing apparatus, for selecting a function supported in the video recording/reproducing apparatus and providing a command, and a main control unit for temporarily storing a received video signal in a buffer area allocated in the storage device if a command for temporary storage is received from the input unit so that a certain amount of the video signal received from the video signal source is temporarily stored in the temporarily allocated buffer area of the storage device, and for recording in the storage device in a long-term basis the video signal temporarily stored in the buffer area according to a set recording format if a recording command instructing a long-term recording process for the temporarily stored video signal of the buffer area is received from the input unit.

The video signal source includes any one of a tuner receiving broadcast signals, a disc player reproducing a signal recorded in a recording medium, and an external input port inputting video signals from external devices. The storage device includes a hard disc driven by a hard disc drive.

The main control unit further operates such that if a recording command instructing the long-term recording process is received from the input unit, the main control unit sets a new buffer area in a non-recording area of the storage device, records in a previous buffer area in a long-term basis a video signal temporarily stored in the previous buffer area, and records attribute information of the long-term recorded video signal in a set attribute information recording area. If the buffer area in which the video signal is temporarily stored has a remaining storage space, the main control unit incorporates the remaining storage space into the non-recording area. If the recording command instructing the long-term recording process is received from the input unit, the main control unit copies and records in the non-recording area of the storage device the video signal temporarily stored in the buffer area, deletes the video signal temporarily stored in the buffer area, and records in the set attribute information recording area the attribute information of the video signal recorded in the non-recording area in the long-term basis. The attribute information of the video signal recorded in the attribute information recording area has at least any one of a start address, an end address, a recording rate, and a recording time of the video signal.

Furthermore, if a command signal for deleting the video signal temporarily stored in the buffer area is received from the input unit, the main control unit deletes the video signal temporarily stored in the buffer area. The video recording/reproducing apparatus further comprises an interface unit mounted in a main body to receive the command transmitted from the input unit. The input unit includes an external input unit which is external of the apparatus. The external input unit includes a remote controller provided with a plurality of keys and transmits infrared signals corresponding to key selections. The interface unit can include a light-receiving part for receiving the infrared signals transmitted from the remote controller.

The above and other object are further substantially achieved by a storage device control method for a video recording/reproducing apparatus capable of storing in a storage device a video signal received from a video signal source, and reproducing and outputting the stored video signal to a display device. The method comprises the step of storing a received video signal in a buffer area allocated in the storage device if a request signal is received from an input unit, such as a remote controller external of the video recording/reproducing apparatus, so that a certain amount of the received video signal from the video signal source is temporarily stored in the temporarily allocated buffer area of the storage device. The method further comprises the step of storing the temporarily stored video signal of the buffer area in a long-term basis according to a set recording format if a recording command instructing a long-term recording process for the temporarily stored video signal of the buffer area is received from the input unit.

The step of storing to the set recording format includes steps of setting a new buffer area in a non-recording area of the storage device, and recording the temporarily stored video signal of a previous buffer area in the previous buffer area in the long-term basis, wherein attribute information of the video signal recorded in the long-term basis is recorded in a set attribute information recording area. The step of storing to the set recording format includes steps of copying and recording the temporarily stored video signal of the buffer area in a non-recording area of the storage device, and deleting the temporarily stored video signal of the buffer area, wherein attribute information of the video signal recorded in the long-term basis in the non-recording area in the deleting step is recorded in a set attribute information recording area.

### BRIEF DESCRIPTION OF THE DRAWINGS

The above object and other features of the present invention will become more apparent by describing in detail an embodiment thereof with reference to the attached drawings, in which:

FIG. 1 is a view for showing a display system to which a video recording/reproducing apparatus according to an embodiment of the present invention is applied;

FIG. 2 is a block diagram of the video recording/reproducing apparatus of FIG. 1;

FIG. 3 is a plan view of a remote controller of FIG. 1;

FIG. 4A is a view for showing an initial menu guide list screen displayed on a display device when a menu key of FIG. 3 is selected;

FIG. 4B is a view for showing a menu guide list screen subsequently displayed when a setup menu of FIG. 4A is selected;

FIG. 4C is a view for showing a menu guide list screen provided to set a buffer time when a buffer time menu of FIG. 4B is selected;

FIG. 5A is a view for schematically showing a hard disc drive structure in which a buffer area is allocated by FIG. 4C;

FIG. 5B is a view for schematically showing a hard disc drive structure after a video signal stored in the buffer area of the hard disc drive of FIG. 5A is stored in an A/V data file; and

FIG. 6 is a flow chart for showing a storage device control method for the video recording/reproducing apparatus according to an embodiment of the present invention.

### DETAILED DESCRIPTION OF THE PREFERRED EMBODIMENT

Hereinafter, an embodiment of the present invention will be described in detail with reference to the accompanying drawings.

Referring to the accompanying drawings, a video recording/reproducing apparatus according to an embodiment of the present invention will be described in detail.

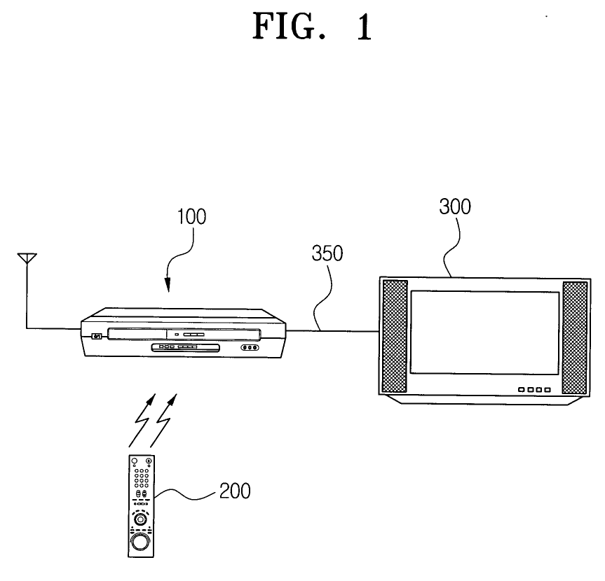

FIG. 1 is a view for schematically showing a display system to which a video recording/reproducing apparatus according to an embodiment of the present invention is applied.

Referring to FIG. 1, a video recording/reproducing apparatus 100 is connected to a television set 300, which operates as a display device, via a transmission cable 350. The video recording/reproducing apparatus 100 processes a signal received from a remote controller 200 which is an external input device, and transmits display information to the television set 300. In this example, the external input device may be a remote controller 200 which transmits wireless signals, such as infrared signals, as well as other input devices such as wire-type keyboards.

The video recording/reproducing apparatus 100 is built to receive at least one or more video signals provided from multiple video sources. The video sources may be ground wave television broadcasts, satellite broadcasts, cable inlet lines, and other media capable of transmitting signals such as computer lines or modem lines.

That is, an embodiment of the present invention to be hereinafter described are applied to a video recording/reproducing apparatus built to be able to receive at least one or more video signals from video sources such as cables, satellite dish antennas, local cables, digital broadcast sources (DBSs), general antennas, the Internet, different computer sources, camcorders, disc players, set top boxes, and so on.

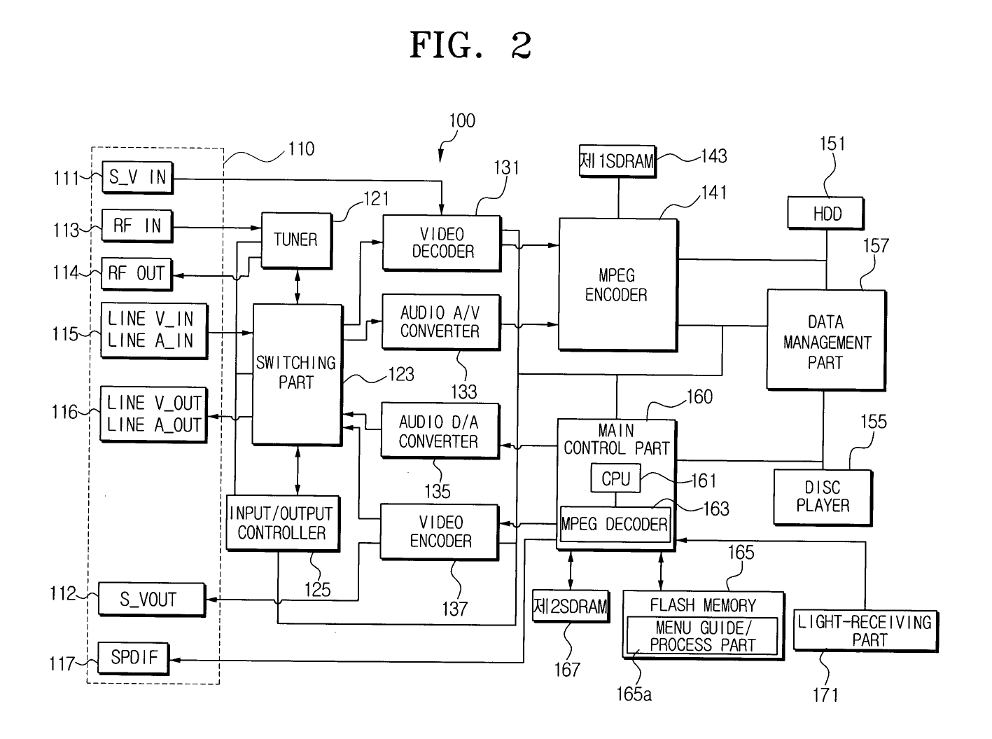

FIG. 2 is a block diagram for showing such a video recording/reproducing apparatus according to an embodiment of the present invention.

Referring to FIG. 2, the video recording/reproducing apparatus 100 has an input/output port part 110, a tuner 121, a switching part 123, an input/output controller 125, an MPEG encoder 141, a hard disc drive (HDD) 151, a disc player 155, and a main control part 160.

The input/output port part 110 can receive signals reproduced from diverse video signal sources, and output received signals or signals reproduced from the hard disc drive 151 employed for a mass storage device.

The input/output port part 110 is provided with a super video input port (S_V IN) 111, a super video output port (S_V out) 112, an RF input port (RF IN) 113, an RF output port (RF OUT) 114, a line video/audio input port (LINE V_IN, LINE A_IN) 115, a line video/audio output port (LINE V_OUT, LINE A_OUT) 116, and a serial parallel digital interface (SPDIF) 117.

A more detailed description of either an input port or an output port with respect to an element having different input/output relations but the same signal format will now be provided. The super video input port 111 is a port for receiving a luminance signal Y and chrominance signals Cr and Cb in the digital format which are separated from each other, and used in connection with a digital camcorder, a DVD player, a set top box, and so on. The RF input port 113 is a port for receiving an air broadcasting signal, which is in general connected to an antenna.

The line video/audio input port 115 is a port for receiving an analog signal mixed with a luminance signal Y and chrominance signals, and used in connection with a camcorder, a DVD player, a set top box, and so on which support an analog video signal output. The digital audio output port 117 is a port for externally outputting a digital audio signal transmitted from the main control part.

The tuner 121 tunes to a reception channel so that a broadcast signal on a channel requested from the input/output controller 125 controlled by the main control part 160 can be received through the RF input port 113. The switching part 123 is controlled by the input/output controller 125 to selectively connect the input/output ports one other which are connected to the switching part 123.

A video decoder 131 is controlled by the main control part 160 to decode and output a signal received through the super video input port 111 or the switching part 123. An audio A/D converter 133 converts to a digital signal an analog audio signal inputted through the switching part 123 and outputs the digital signal to the MPEG encoder 141.

The MPEG encoder 141 is controlled by the main control part 160 to encode an audio signal outputted from the audio A/D converter 133 and a video signal output from the video decoder 131 in a set compression format, and stores data to be stored in the hard disc drive 151 of mass storage device. Preferably, the MPEG encoder 141 carries out encoding based on MPEG-2 compression format.

A first SDRAM 143 denotes a memory employed upon an encoding process in the MPEG encoder 141. A data management part 157 manages the reproductions and records of data stored in the hard disc drive 151 and/or in a recording medium mounted to the disc player 155. That is, the data management part 157 is controlled by the main control part 160 to manage the storage of the data recorded in the recording medium mounted to the disc player 155 onto the hard disc drive 151, the storage of data stored on the hard disc drive 151 to the disc player 155, or the storage of the data encoded in the MPEG encoder 141 onto the hard disc drive 151.

The disc player 155 is built in the video recording/reproducing apparatus. The disc player 155 may be a DVD player for reproducing data stored in a recording medium such as a digital video disk (DVD) and/or a compact disc (CD). The disc player 155 is controlled by the main control part 160 so as to perform recording/reproducing operations.

A light-receiving part 171 is applied as an interface unit, which receives and outputs to the main control part 160 a user manipulation signal output from an external input device such as the remote controller 200. The main control part 160 processes the user manipulation signal received through the light-receiving part 171 and controls the respective parts of the apparatus. The main control part 160 is formed of a single IC chip combining a central processing unit (CPU) 161 and an MPEG decoder 163 for decoding a compressed signal in MPEG format. The MPEG decoder 163 may be separated as an extra chip and be connected to the main control part 160.

A flash memory 165 stores various programs related to the performance of the function of the main control part 160. The flash memory 165 is installed with a menu guide/process part 165a in which a graphic user interface (GUI) program is stored that carries out a process of the menu guide list screen to be described later. A second SDRAM 167 is a temporary storage space used by the main control part 160.

The audio D/A converter 135 converts into an analog audio signal a digital audio signal outputted from the MPEG decoder 163 of the main control part 160 and outputs the analog audio signal to the switching part 123. A video encoder 137 encodes a video signal outputted from the video decoder 131 and the MPEG decoder 163 and outputs the decoded video signal to the switching part 123. The input/output controller 125 is controlled by the main control part 160 to control the tuner 121 and the switching part 123. The main control part 160 in such a video recording/reproducing apparatus loads operating programs built in the flash memory 165 to process various functions corresponding to a signal received through the light-receiving part 171 from the remote controller 200.

Hereinafter, the storage device control method of the main control part based on key selections from the remote controller is described in detail in connection with processing the menu guide list screen.

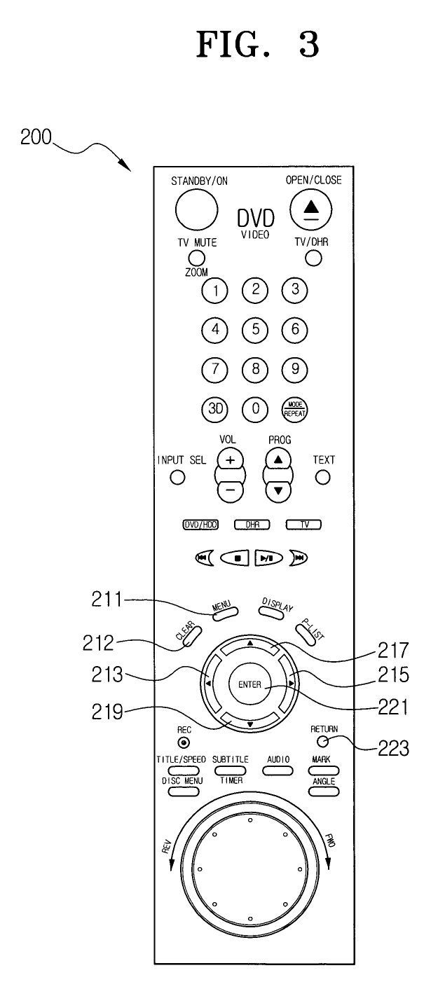

The manipulations of a menu guide list screen will now be described with reference to FIG. 3 in which the remote controller 200 is shown as an external input device for the video recording/reproducing apparatus 100 according to an embodiment of the present invention.

Referring to FIG. 3, a reference number 211 denotes a menu key used when loading and closing a menu guide list screen, and reference numbers 213, 215, 217, and 219 denote up, down, left, and right direction keys employed for cursor movements with respect to classified items listed on the menu guide list screen to be described later. Further, a reference number 221 denotes an enter key used when selecting menus, and 223 a return key used when returning a current screen to a previous screen.

The rest of the keys are well-known keys and specific keys for manipulating the video recording/reproducing apparatus 100 and the television set 300, the functions of which can be easily understood through descriptive lettering set forth nearby the corresponding keys, and detailed descriptions of the functions of the keys will be omitted since there exists no difficulties in understanding the present invention.

Hereinafter, a description will be made on a method producing an audio and video data file after temporarily storing a video signal in a storage device provided with the video recording/reproducing apparatus with reference to the accompanying drawings.

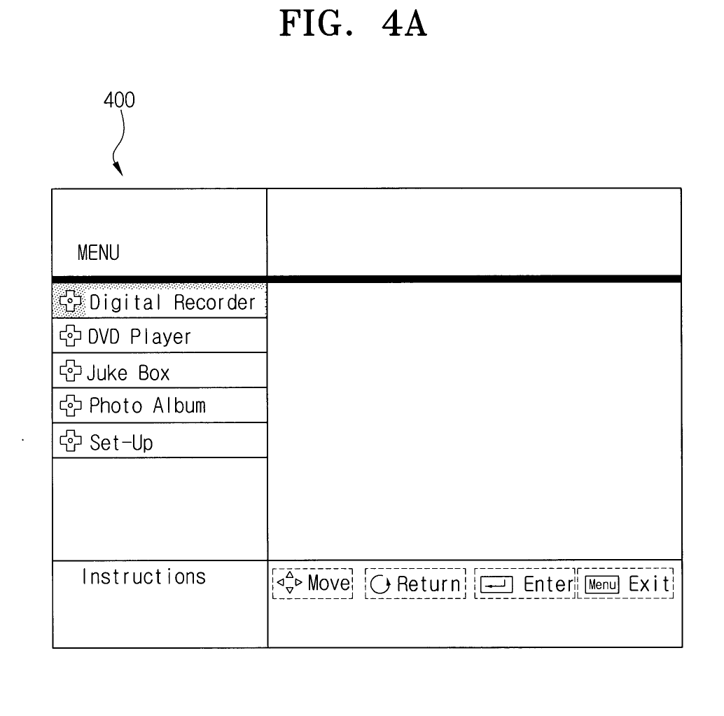

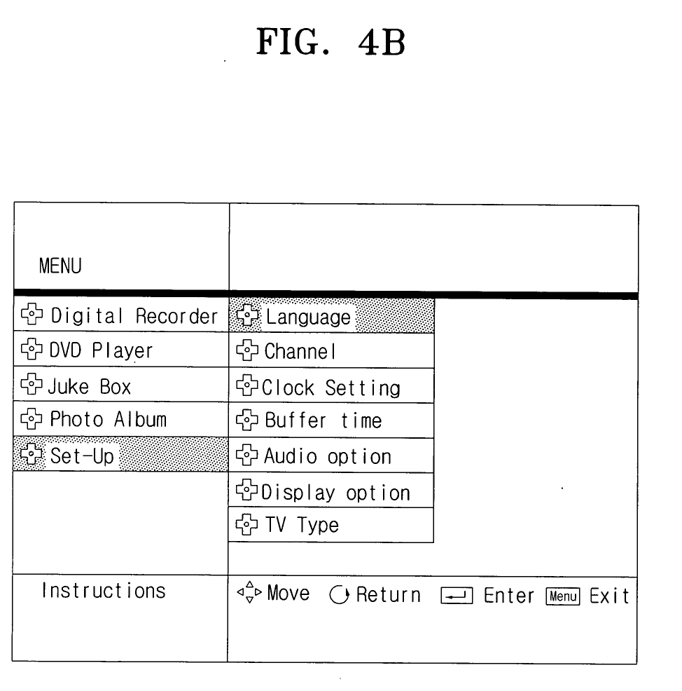

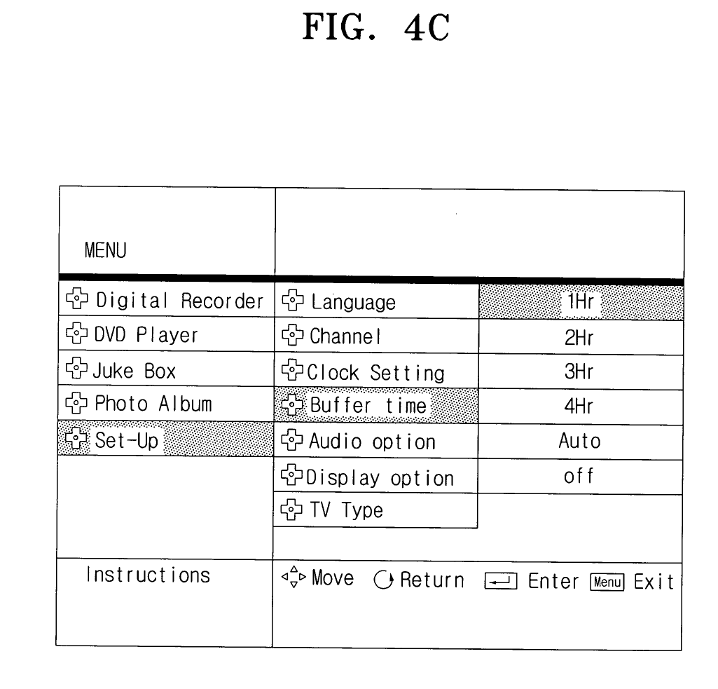

FIG. 4A is a view showing an initial menu guide list screen displayed in a display device when the menu key of FIG. 3 is selected.

Referring to FIG. 3 and FIG. 4A, if the light-receiving part 171 receives a signal generated when the menu key 211 of the remote controller 200 is selected, the main control part 160 launches the GUI program stored in the menu guide/process part 165a to provide an initial menu guide list screen 400 on the television set 300 through the line video/audio output port 116.

If a “Set-Up” menu is selected from the main menus of the initial menu guide list screen 400 by using the direction keys 213, 215, 217, and 219 and the enter key 221 of the remote controller 200, as shown in FIG. 4B, a first submenu belonging to the “Set-Up” menu is displayed together with the main menus.

Further, if a “Buffer Time” menu is selected from the menus shown in FIG. 4B by using the direction keys 213, 215, 217, and 219 and the enter key 221 of the remote controller 200, as shown in FIG. 4C, a second submenu belonging to the “Buffer Time” menu is displayed together with the main menus and the first submenu. FIG. 4C is a view for showing an illustrative screen provided to enable the “Buffer Time” to be set.

Referring to FIG. 4C, the “Buffer Time” of the first submenu is a time shift function used when setting a video signal received from a selected video signal source to be temporarily stored in the hard disc drive 151 in a first-in first-out manner by an amount corresponding to a menu supported in the second submenu. For example, if a “1 Hr” menu is selected from the second submenu by using the remote controller 200, a setting is made to temporarily store in the hard disc drive 151 a video signal received from a predetermined video signal source by a 1-hour amount, and, if a “2 Hr” menu is selected, setting is made to temporarily store a received video signal in the hard disc drive 151 by a 2-hour amount.

Further, if the “Auto” menu is selected, setting is made to temporarily store a received video signal in all the space of the hard disc drive 151 as much as available for storage, and, if the “Off” menu is selected, a received video signal is not temporarily stored in the hard disc drive 151. The video signal source includes at least one of the tuner 121 receiving broadcast signals, a disc player 155 reproducing a signal recorded in a DVD, and the external input ports 111, 113, and 115 inputting video signals from external devices.

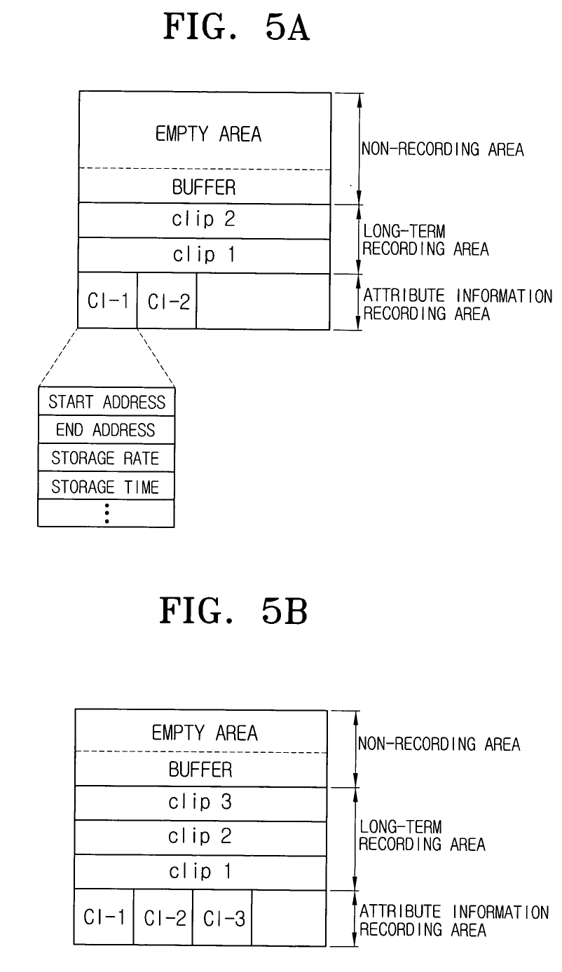

FIG. 5A is a view for schematically showing a structure of the hard disc drive in which a buffer area is allocated by FIG. 4c.

Referring to FIG. 5A, the hard disc drive 151 is divided into a long-term recording area, attribute information recording area, and a non-recording area. The non-recording area refers to an area in which any data such as video signals is not stored nor recorded, but in which data for a video signal can be recorded by the control of the main control part 160 in case that a recording instruction for a received video signal is applied from the remote controller 200.

For more details, if a certain buffer time is selected by the remote controller 200 from a menu list guide screen as in FIG. 4C which is displayed on the television set 300, a buffer area is allocated in the non-recording area by an amount corresponding to the selected buffer time. The remaining area except for an area allocated as the buffer area of the non-recording area remains as an empty area.

If the buffer time selected from the menu list guide screen of FIG. 4C is “1 Hr”, a buffer area is allocated in part of the non-recording area to store a received video signal by a “one-hour” amount. Further, if the buffer time selected from the menu list guide screen is “Auto”, the buffer area is allocated over the entire non-recording area.

The buffer area is an area which can temporarily store a received video signal by an amount of hours selected in advance in the first-in first-out (FIFO) manner. For example, if a “2 Hr” buffer time and a video signal source for temporary storage are selected from the remote controller 200 and a start time at which a video signal is temporarily stored is “one o'clock in the afternoon”, a video signal from 1 p.m. to 3 p.m. is temporarily stored in the buffer area. Further, even though the start time at which a video signal is temporarily stored is “one o'clock in the afternoon”, a video signal of two-hour amount such as from 2:30 p.m. to 4:30 p.m., from 3 p.m. to 5 p.m., and the like is temporarily stored in the buffer area with time progress in the FIFO manner while shifting in the buffer area.

The long-term recording area is an area for recording a video signal in a long term basis by storing the video signal as an audio and video (AV) data file based on a user's recording instruction. The long-term recording AV data file can be recorded for a long time as well as edited according to a user's preference.

In the attribute information recording area, attribute information of a video signal is registered and recorded as a clip stored in an AV data file. The attribute information of the video signal includes a start address, end address, recording rate, recording time, and so on, of an AV data file in which a video signal is stored, of which at least one attribute is recorded in the attribute information recording area.

The attribute information recording area has a time map (TMAP) structure by which a video signal temporarily stored in the buffer area is registered as a clip. The TMAP connects attribute information on a video signal, that is, connects recording positions with video signal data corresponding thereto.

In the long-term recording area of FIG. 5a is recorded clip 1 and clip 2 which are two A/V data files registered as clips, and in the attribute information recording area is recorded attribute information CI-1 (Clip Information-1) and CI-2 (Clip Information-2) for the clip 1 and clip 2.

FIG. 5b is a view for schematically showing a structure of the hard disc drive after a video signal stored in the buffer of the hard disc drive of FIG. 5a is stored as an A/V data file.

If a recording command instructing a long-term recording process with respect to a video signal temporarily stored in the buffer area of FIG. 5a is received from the remote controller 200, the video signal temporarily stored in the buffer area is recorded in the hard disc drive 151 in a long term basis according to a set recording format. The recording command for the long-term recording process refers to the storage of a temporarily stored video signal into an A/V data file.

The set recording format for recording a temporarily stored video signal is mainly classified into two.

Firstly, if a recording command instructing a long-term recording process is received from the remote controller 200, the main control part 160 sets a new buffer area with respect to the non-recording area of the hard disc drive 151, and records in a long term basis a video signal temporarily stored in a previous buffer area, for example, as clip 3 of FIG. 5b in the previous buffer area. At this time, the main control unit 160 processes the attribute information on the video signal recorded in a long term basis to be recorded as CI-3 in the attribute information recording area. Preferably, if a buffer area in which a video signal is temporarily stored has an extra storage area, the main control part 160 incorporates the extra storage area into the non-recording area. For example, in case that the buffer time of “2 Hr” is selected and set from the remote controller 200 and the actual amount of a video signal temporarily stored in the buffer area corresponds to “one hour”, the buffer area corresponding to the remaining “one hour” long amount is incorporated into the non-recording area.

Secondly, if a recording command instructing a long-term recording process is received from the remote controller 200, the main control part 160 copies a temporarily stored video signal into the buffer area, records it in the non-recording area of the hard disc drive 151, and deletes the video signal temporarily stored in the buffer area. At this time, the main control part 160 records in the set attribute information recording area the attribute information of the video signal copied and recorded in a long-term basis in the non-recording area. Further, the buffer area from which the temporarily stored video signal is deleted is incorporated into the nonrecording area.

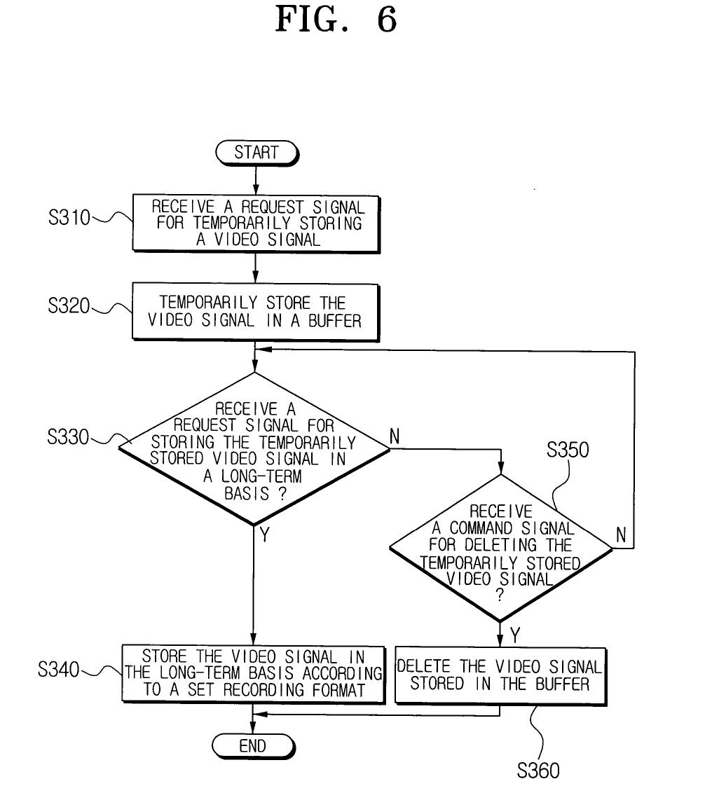

FIG. 6 is a flow chart for showing a storage device control method for the video recording/reproducing apparatus according to an embodiment of the present invention.

Referring to FIG. 6, if a request signal is received from the remote controller 200 to temporarily store a certain amount of a video signal received from a video signal source in a temporarily allocated buffer area of the hard disc drive 151 (step S310), the main control part 160 temporarily stores the received video signal in the buffer area (step S320). Further, if a request signal is received from the remote controller 200 to store in a long-term basis the video signal temporarily stored in the buffer area (step S330), the main control part 160 stores the video signal in the buffer area in the long-term basis according to a set recording format (step S340). The step S340 is a step for generating an A/V data file with respect to the temporarily stored video signal.

If a long-term storage request signal is not received for the temporarily stored video signal in the S330, the main control part 160 checks whether a delete command signal is received for the temporarily stored video signal (step S350). If the delete command signal is received from the step S350, the main control part 160 deletes the video signal temporarily stored in the buffer area (step S360).

The video recording/reproducing apparatus and the storage device control method thereof according to the embodiment of the present invention described above can temporarily allocate the buffer area in an extra space of a storage device mounted to the video recording/reproducing apparatus, and temporarily store a received video signal in the allocated buffer area. Further, the allocated amount of the buffer area can be adjusted according to a user's selection. Furthermore, the embodiment of the present invention generates and stores in a long-term basis an A/V data file for the temporarily stored video signal, to thereby enable time-delayed viewings.

While the invention has been shown and described with reference to an embodiment thereof, it will be understood by those skilled in the art that various changes in form and details may be made therein without departing from the spirit and scope of the invention as defined by the appended claims.

What is claimed is:

1. A video recording/reproducing apparatus capable of storing in a storage device a video signal received from a video signal source, and reproducing and outputting the stored video signal to an display device, comprising:
an input unit for selecting a function supported in the video recording/reproducing apparatus and outputting a command; and
a main control unit for temporarily storing a received video signal in a buffer area allocated in the storage device if a command for temporary storage is received from the input unit so that a certain amount of the video signal received from the video signal source is temporarily stored in the temporarily allocated buffer area of the storage device, and for recording in the storage device in a long-term basis the video signal temporarily stored in the buffer area according to a set recording format if a recording command instructing a long-term recording process for the temporarily stored video signal of the buffer area is received from the input unit.

2. The video recording/reproducing apparatus as claimed in claim 1, wherein:
if the recording command instructing the long-term recording process is received from the input unit, the main control unit sets a new buffer area in a non-recording area of the storage device, records in a previous buffer area in a long-term basis a video signal temporarily stored in the previous buffer area, and records attribute information of the long-term recorded video signal in a set attribute information recording area.

3. The video recording/reproducing apparatus as claimed in claim 2, wherein:
if the buffer area in which the video signal is temporarily stored has a remaining storage space, the main control unit incorporates the remaining storage space into the non-recording area.

4. The video recording/reproducing apparatus as claimed in claim 2, wherein:
if the recording command instructing the long-term recording process is received from the input unit, the main control unit copies and records in the non-recording area of the storage device the video signal temporarily stored in the buffer area, deletes the video signal temporarily stored in the buffer area, and records in the set attribute information recording area the attribute information of the video signal recorded in the non-recording area in the long-term basis.

5. The video recording/reproducing apparatus as claimed in claim 2, wherein:
the attribute information of the video signal recorded in the attribute information recording area has at least any one of a start address, an end address, a recording rate, and a recording time of the video signal.

6. The video recording/reproducing apparatus as claimed in claim 1, wherein:
if a command signal for deleting the video signal temporarily stored in the buffer area is received from the input unit, the main control unit deletes the video signal temporarily stored in the buffer area.

7. The video recording/reproducing apparatus as claimed in claim 1, further comprising:
an interface unit mounted in a main body to receive the command transmitted from the input unit.

8. The video recording/reproducing apparatus as claimed in claim 1, wherein:
the input unit includes an external input unit which is external of the apparatus.

9. The video recording/reproducing apparatus as claimed in claim 8, wherein:
the external input unit includes a remote controller provided with a plurality of keys and transmits infrared signals corresponding to key selections.

10. The video recording/reproducing apparatus as claimed in claim 9, further comprising:
an interface unit mounted in a main body and including a light-receiving part for receiving the infrared signals transmitted from the remote controller.

11. The video recording/reproducing apparatus as claimed in claim 1, wherein:
the video signal source includes any one of a tuner receiving broadcast signals, a disc player reproducing a signal recorded in a recording medium, and an external input port inputting video signals from external devices.

12. The video recording/reproducing apparatus as claimed in claim 1, wherein:
the storage device includes a hard disc driven by a hard disc drive.

13. A storage device control method for a video recording/reproducing apparatus capable of storing in a storage device a video signal received from a video signal source, and reproducing and outputting the stored video signal to a display device, comprising steps of:
storing a received video signal in a buffer area allocated in the storage device if a request signal is received from an input unit so that a certain amount of the received video signal from the video signal source is temporarily stored in the temporarily allocated buffer area of the storage device; and
storing the temporarily stored video signal of the buffer area in a long-term basis according to a set recording format if a recording command instructing a long-term recording process for the temporarily stored video signal of the buffer area is received from the input unit.

14. The storage device control method as claimed in claim 13, wherein the step of storing to the set recording format includes steps of:
setting a new buffer area in a non-recording area of the storage device;
recording the temporarily stored video signal of a previous buffer area in the previous buffer area in the long-term basis, wherein attribute information of the video signal recorded in the long-term basis is recorded in a set attribute information recording area.

15. The storage device control method as claimed in claim 13, wherein the step of storing to the set recording format includes steps of:
copying and recording the temporarily stored video signal of the buffer area in a non-recording area of the storage device; and
deleting the temporarily stored video signal of the buffer area, wherein attribute information of the video signal recorded in the long-term basis in the non-recording area in the deleting step is recorded in a set attribute information recording area.

16. The storage device control method as claimed in claim 13, wherein:
the input unit is external of the video recording/reproducing apparatus.
